(19) United States
(12) Patent Application Publication
(10) Pub. No.: US 2005/0167535 A1
(43) Pub. Date: Aug. 4, 2005

(54) Paper shredder and transfer truck

(76) Inventor: Bob Rajewski, Stettler (CA)

Correspondence Address: THOMPSON LAMBERT;SUITE 703D, CRYSTAL PARK TWO, 2121 CRYSTAL DRIVE, ARLINGTON, VA, 22202, US

(21) Appl. No.: 10/771,122

(22) Filed: Feb. 4, 2004

(51) Int. Cl. B02C 18/22

(52) U.S. Cl. 241/100; 241/236

(57) ABSTRACT

A paper shredder has a feed compartment, paper shredding implements and an auger disposed with a transfer tube, the auger having flights and wear plates on the flights to stabilize the auger within the transfer tube. The wear plates may be made of spark resistant material. The wear plates may also be replaceable. The auger may also be driven by a direct drive from a vehicle transmission drive shaft. A transfer truck for transporting materials to an off-site shredding facility has a frame mounted on wheels, at least one compartment mounted to the frame, the compartment comprising a top, a floor, sides, an ejector wall, an opening for receiving materials for shredding, and a door for offloading materials for shredding, the ejector wall capable of movement towards and away from the door to push out materials for shredding from the transfer truck. The floor of the transfer truck may be ribbed. The ejector wall may have a vertical portion and an angled portion adjacent the floor.

### BACKGROUND OF THE INVENTION

This invention relates to a paper shredding assembly adapted for use on a truck or like vehicle. This invention also relates to a transfer truck for use in hauling materials for shredding

Truck-mounted paper shredding assemblies (“shredders”) are commonly in use today. These units move about from one office to another to shred often confidential paper documents.

For a long time, mobile paper shredders used knives or cam type cutting devices to shred the paper into strips. In general, these shredders rely on manual feeding of paper to ensure that the paper enters the machine at an even thickness and rate. As a consequence, they are relatively slow in processing paper.

U.S. Pat. No. 5,542,617, issued to D. E. Rajewski, discloses the use of a rotary hammer mill to shred the paper. Canadian patent no. 2,225,900 issued, Sep. 26 2000, discloses a further truck-mounted paper shredder. The shredder uses a reciprocating plunger to feed a rotary hammer mill, which shreds the paper. An auger is used to transfer the shredded paper into a discrete storage container. The container. The container is separate so that it can be removed when loaded and left standing for later pick-up, allowing the truck and shredder to take on an empty container and move on to the next job.

While these hammer-type paper shredders appear to have performed their intended functions, paper dust caused by the hammer action caused an explosion hazzard and the feed mechanisms were awkward to use. Canadian patent application 2,432,199, filed Jun. 13, 2003 by the invention of the present application, sought to remedy some of these problems. It discloses an improved feed mechanism, as well as a sprayer to keep down dust caused by the paper shredding implements. While the sprayer works well to reduce the risk of an explosion hazard, the present invention is directed towards further improvements to a paper shredder, particularly an improved mobile paper shredder using hammers.

There are times when either the location of the materials for shredding or the quantity of materials for shredding make it inconvenient to shred the materials on site. For example, if the location is far from a recycling facility or otherwise particularly remote, the added time and expense involved in shredding the materials on-site and then hauling them to another location for recycling, or alternatively, in leaving the container on-site for later retrieval, might make it uneconomical or not feasible to shred materials on-site if there is a lack of extra containers to be left behind. Also, some sites may have such a great quantity of materials for shredding that multiple containers would be required, and in consequence, multiple trips to retrieve those containers would also be required.

Therefore, the present invention is also directed to an improved transfer truck for transporting materials for shredding, as well as to an improved method of shredding materials from different locations, particularly using a transfer truck as taught by the present invention.

### SUMMARY OF THE INVENTION

There is therefore provided in accordance with an aspect of the invention, a paper shredder that has a feed compartment, paper shredding implements disposed to receive paper from the feed compartment and discharge shredded paper, and an auger disposed within a transfer tube to receive shredded paper discharged by the paper shredding implements and to convey shredded materials to a storage container, the auger having flights and wear plates on the flights to stabilize the auger within the transfer tube.

According to a further aspect of the invention, the wear plates are made of spark resistant material. They may also be replacable.

According to a further aspect of the invention, the auger is driven by a direct drive from a vehicle transmission drive shaft.

According to further aspect of the invention, there is provided a transfer truck for transporting materials for shredding to a shredding site, the transfer truck comprising a frame mounted on wheels, at least one compartment for storing materials for shredding mounted on the frame, the compartment comprising a top, a floor, sides, and ejector wall, an opening for receiving materials for shredding, and a door for offloading materials for shredding, the ejector wall capable of movement towards and away from the door to push out materials for shredding from the transfer truck.

According to a further aspect of the invention, the floor of the transfer truck is ribbed.

According to a further aspect of the invention, the ejector wall has an angled portion and a vertical portion, the angled portioned being adjacent to the floor and the vertical portion extending toward the top.

These and other aspects of the invention may be found in the detailed description that follows and in the claims.

### BRIEF DESCRIPTION OF THE DRAWINGS

There will now be described a preferred embodiment of the invention, with reference to the drawings by way of illustration only, in which like reference characters denote like elements and in which:

FIG. 1 is a side elevation showing a shredder mounted on a truck, the shredder being shown in section;

FIG. 2 is a side elevation, partly in section, showing the first housing of a shredder on a truck and a storage container left standing on the ground awaiting pick up and removal;

FIG. 3 is a front end elevation of the shredder, showing internals in broken lines;

FIG. 4 a perspective view, with part of the housing and some parts removed, showing the internals of the feed compartment of the shredder;

FIG. 5 is a side view of a hopper divider according to the invention;

FIG. 6 is a side elevation, in section, showing the shredder and storage container linked in working relationship;

FIG. 7 is side view of the paper shredder of FIG. 6;

FIG. 8 is a perspective view of the auger assembly;

FIG. 9 is a side elevation showing a transfer truck;

FIG. 10 is a side elevation showing a transfer truck with the door open; and

FIG. 11 is a side view of a compartment of the transfer truck, partly in section, showing the ejector wall;

FIG. 12 is a perspective view of the compartment of the transfer truck with the ejector wall in a retracted position; and

FIG. 13 is a perspective view of the compartment of the transfer truck with the ejector wall in an advanced position.

### DESCRIPTION OF PREFERRED EMBODIMENTS

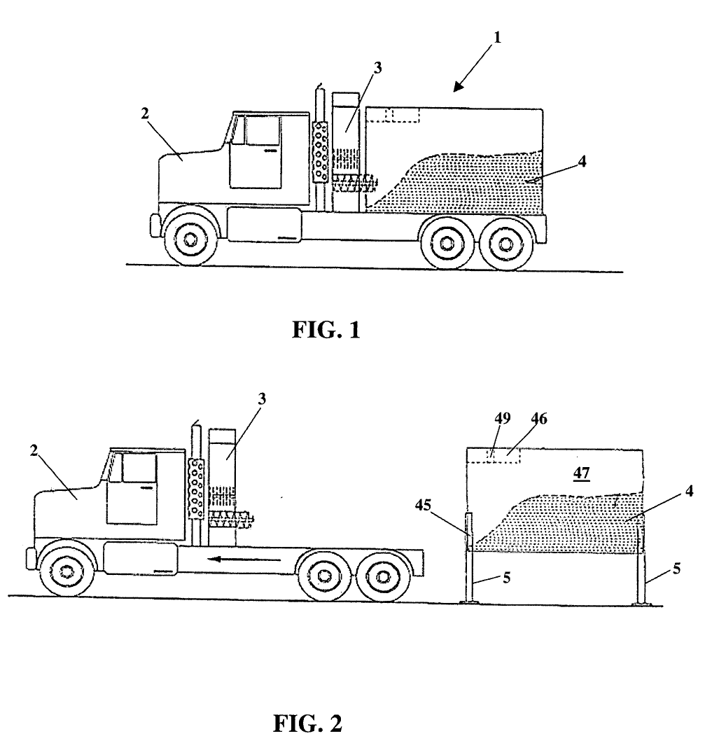

Having reference to FIG. 1, a paper-shredding assembly 1 is shown mounted on a truck 2. The assembly 1 comprises a shredder 3 which remains with the truck. The assembly 1 further comprises a storage container 4 which can operatively connect with the shredder 3, as shown in FIG. 1, or can be removed from the truck and be left standing on telescoping legs 5.

More particularly, the shredder 3 comprises a housing 6 forming an upper feed compartment 7 and a lower chamber 8.

The feed compartment 7 is generally rectangular and has top, bottom and side walls 9, 10, 11 and first and second ends. At its first end, the top wall 9 forms a paper feed opening 13 having a hinged lid 14. Lifting arms 15, pivotally attached to the housing 6, are provided to lift a receptacle 16 and tip it to empty contained paper into the paper feed opening 13.

A hydraulic cylinder 17, pivotally attached to the housing 6 and arms 15, is provided to actuate the arms. Rubber belting 18 hangs partway down from the compartment top wall 9 and divides the compartment 7 into first and second sections 19, 20. The feed compartment bottom wall 10 forms a hammer mill opening 21 adjacent its second end. A sloped baffle 100 extends down from the first end side wall 11 and combines with the belting 18 to form a downwardly tapering feed passage 101.

A plunger 22 is located beneath the baffle 100 and on the bottom wall 10 at its first end. The plunger 22 extends transversely across the width of the feed compartment 7. A hydraulic cylinder 24 is connected at one end with the plunger 22 by a lug 25 extending through a slot (not shown) in the bottom wall 10. At its other end, the cylinder 24 is connected with a stationary lug 26 connected to the underside of the bottom wall 10. The cylinder 24 contracts to advance the plunger 22 along the bottom wall 10 toward the hammer mill opening 21 and expands to retract the plunger to the first end of the compartment 7. The cylinder 24 is actuated by the truck's hydraulic system (not shown). It is contemplated that an auger could be substituted for the plunger 22. However, the plunger 22 is preferred.

A hammer mill 30 is positioned in the lower chamber 8 immediately below the opening 21. The mill 30 comprises a shaft 31 carrying flails or hammers 32. It is contained within a semi-circular screen 33. The hammer mill is mounted to the side walls 11. It is driven by a pulley and belt system 34 connected with the power take-off (not shown) of the truck 2. The hammer mill 30 is positioned so that its hammers 32 will protrude through the opening 21 up into the feed compartment 7 when rotating. A wall 35 combines with the housing 6 to form a narrowing hopper 36 for guiding shredded paper produced by the mill down to the auger assembly 40.

The auger assembly 40 comprises a screw auger 41 working within a transfer tube 42. It is mounted to the compartment side walls 11 and is below and aligned with the hammer mill 30. The transfer tube 42 is semi-circular along its length within the lower chamber 8 and then changes to a fully tubular form as it extends through the side wall 11. As shown, the auger assembly 40 protrudes out of the housing 6. The auger at this end is longer than the tube 42 so that the flights 43 will release the paper being transferred and act like a screw to compress paper in the storage chamber 47. The auger 41 is driven by the pulley and belt assembly 34. The auger 41 is coupled to the assembly 34 by a planetary gear (not shown) so that it can apply increasing torque at constant rotational speed, to maintain its feed rate while compressing the shredded paper 44.

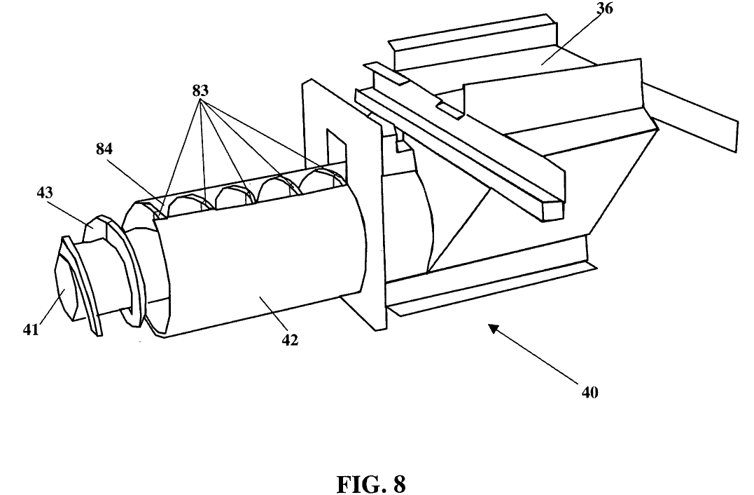

Alternatively, as shown in FIG. 8, the transfer tube 42 may have a relief slot 84 in the top to allow paper to be removed from the auger 41 in the event of a jam in the transfer tube 42. The relief slot 84 has the added advantage of allowing shredded material to spill out of the transfer tube 42 over a broader area during normal operation. 34. If the transfer tube has a relief slot 84, the flights 43 may be confined entirely within the transfer tube 42.

The auger assembly 40 may also be driven by a direct drive from the vehicle transmission. In this embodiment, the vehicle engine is connected to the transmission, from which a shaft 34 extends to a gear on the rear axle. The gear will have a high speed, low speed and neutral position. A pulley hub on the shaft is connected by a pulley to the auger through an auger gear that also has a neutral position. To drive the auger, the rear gear on the vehicle is place in neutral and the auger gear engaged. In this manner, the auger may be driven by the vehicle transmission.

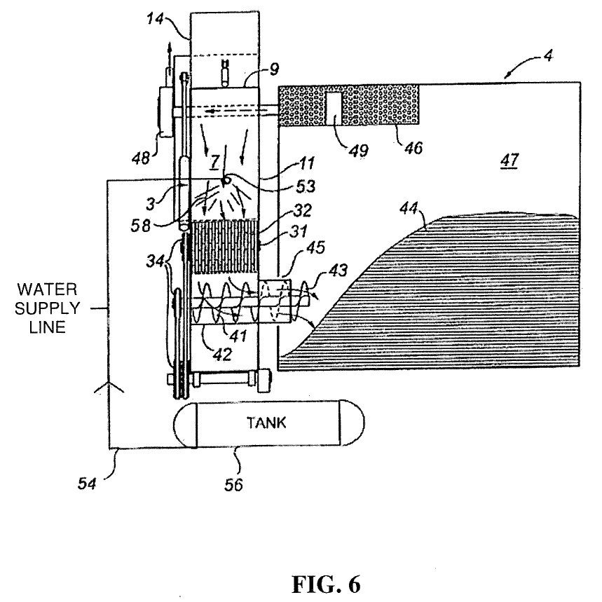

As shown in FIG. 6, the storage container 4 may be a discrete closed box having an inlet 45 through which the auger assembly 40 extends. A filter 46 is mounted to the container 4 within the upper reaches of the storage chamber 47 and is connected with an external blower 48. The blower 48 exerts suction to pull air through the shredder 3 and storage chamber 47 to remove dust. The dust accumulates in the filter 46 and can be dislodged at the end of the shredding run by an air hammer 49, so that it drops into the loaded storage chamber 47. As previously stated the storage container 4 has telescoping legs 5 which can be extended to the ground.

The truck used has an air ride suspension. Its deck can be lowered by letting air out of the suspension. In this way the truck can drive out from beneath the container 4 and leave it standing for recovery by a truck dedicated to moving containers to the paper recycling facility.

In operation, a loaded receptacle 16 from the office is wheeled to the mobile shredder assembly 1. The arms 15, biased by the cylinder 52, are actuated to lift and tip the receptacle so that its contents are dumped into the feed compartment front section 19. The paper slides down the baffle 100 to the front of the plunger 22. The plunger biases it to the hammer mill opening 21. The hammers 32 engage and drive the paper into the impact fingers (not shown) to shred the paper. The belting 18 isolates paper thrown up by the hammers and keeps it in the compartment back section 20. Shredded paper exits the hammer mill screen 33 and drops through the hopper 36 into the open auger 41. The flights 43 of the auger advance the shredded paper into the storage chamber 47. The last few flights 43, located beyond the end of the transfer tube 42, function to compress the shredded paper as it fills the chamber 47. The blower 48 functions to draw produced dust through the shredder 3 and storage container 4 into the filter 46, wherein the dust collects. The air hammer 49 can be actuated at the completion of shredding, to dislodge the dust so that it drops into the loaded storage removal for removal.

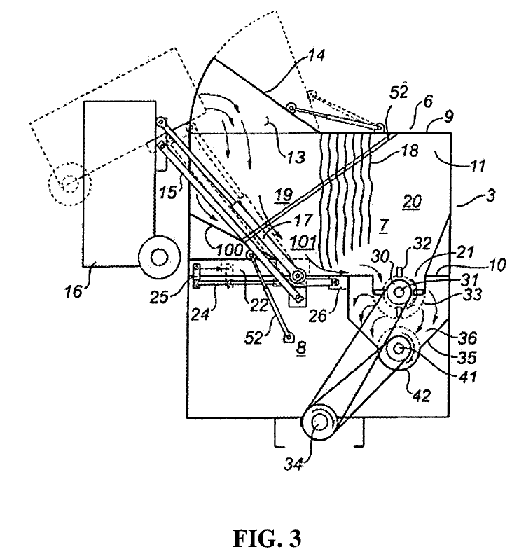

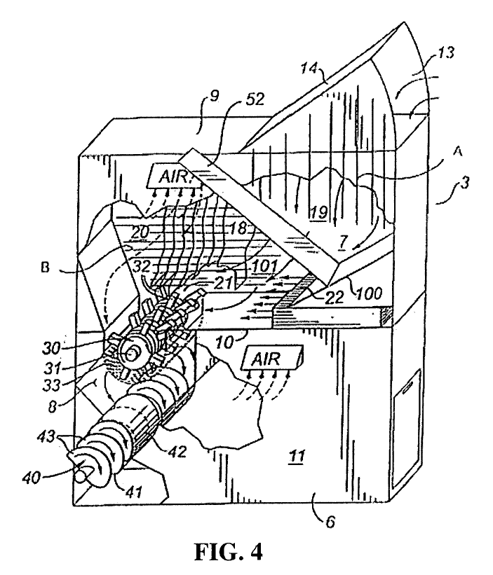

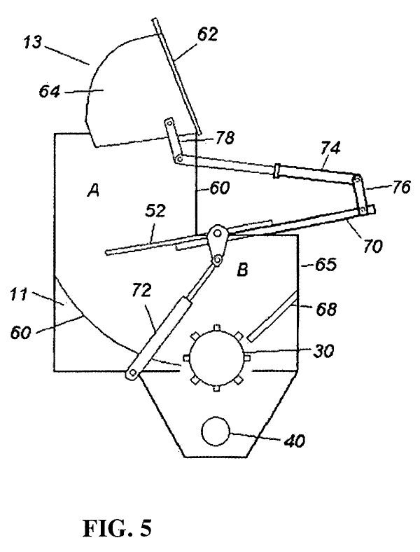

Referring now to FIGS. 3 and 4, a sliding gate 52 divides the feed compartment 7 into a temporary storage space A and a paper shredding space B. The gate 52 is preferably mounted transversely between the feed opening 13 and the hammers 32. The gate 52 may slide on guides (not shown) on either side of the feed compartment 7 or may be supported by a rack (not shown in FIG. 4, but see FIG. 5 discussed below) or other suitable mechanism in the feed compartment 7. The gate 52 may terminate in its travel against the ramp or sloping baffle 100.

An embodiment of the gate 52 is further illustrated in FIG. 5. In this embodiment, the upper part of the walls 11 of the shredder form a hopper 60 having a hinged lid 62. The hinged lid 62 has flanges 64 which surround the opening 13 through which paper may be fed into the shredder. The lower part of the walls 11 surround a paper shredding compartment 65 that contains a hammer mill 30. A ribbed arcuate feed floor 66 guides paper from the hopper 60 towards the hammer mill 30. A further ribbed feed floor 68 extends at the rear of the shredding compartment 65. The hammers 32 pass through between ribs of the ribbed floors 66, 68 in conventional fashion. Shredded paper falls through to an auger 40 below the hammer mill 30. Gate 52 slides on a rack 70 that is secured to the compartment 65. A hydraulic cylinder 72 may be used to open and close the gate 52. A further hydraulic cylinder 74 for opening the lid 62 is mounted on an arm 76 extending from the rack 70 and attached to the lid 62 through a pivoting link 78. Both hydraulic cylinders 72, 74 may be powered by the truck hydraulics.

In both FIGS. 4 and 5, gate 52 divides the shredder into paper storage compartment A and shredding compartment B. The gate 52 may be closed to allow paper to be placed in A while paper in B is being shredded. Once paper in B is shredded, the gate 52 may be opened while the feed compartment opening remains closed to release paper from A into B. This arrangement provides an air lock effect that reduces discharge of paper fragments and dust into the air and regulates the supply of paper into the paper shredding compartment 65.

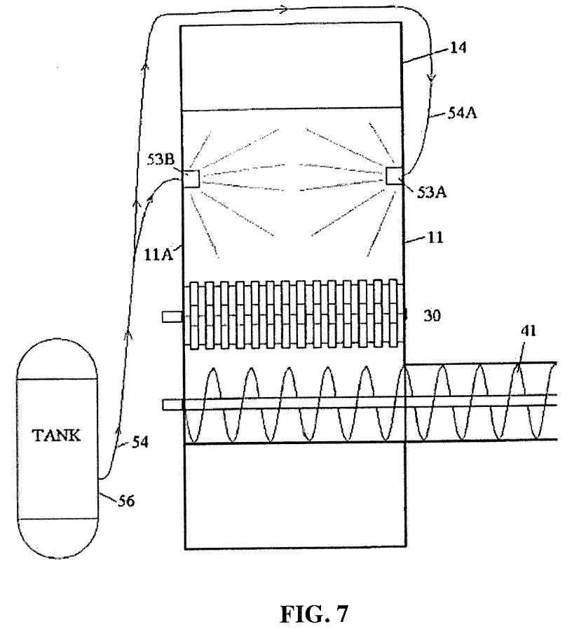

Referring now to FIGS. 6 and 7, a water sprayer 53 is disposed in the feed compartment 7, and is connected through a line 54 to a supply tank 56. The supply tank 56 is preferably a pressurized supply of water, that may be pressurized using compressed air from the truck 2. The sprayer 53 may be any suitable arrangement of nozzles that discharges water as shown in 58 into the feed compartment 7 at any convenient location that allows the water spray to envelope the hammers 32 and cause dust to settle. As shown in FIG. 7, the sprayer 53 may be formed by a pair of nozzles 53A, 53B fed respectively by lines 54 and 54A, and which are mounted on opposed side walls 11 and 11A of the paper shredder. A continuous supply of water should be chosen that is sufficient to remove dust particles from the air, but not saturate the paper. An exemplary water feed rate is 1 gal/minute for a paper feed rate of 6000 lbs/hr. A typical water feed rate range is 0-5 gal/min. The nozzles 53A, 53B may be mounted about 12 inches above the hammer mill 30. Nozzles such as are used for spraying crops may be used. The moist environment generated by the water sprayer 53 keeps dust down and reduces the risk of an explosion. Other fire suppression fluids may be substituted for the water, but it is preferred to use water due to its low cost and easy availability.

To further reduce the risk of an explosion hazard, the auger 41 may be equipped with wear plates 83 on the flights 43, as shown in FIG. 8. The wear plates 83 also help to stabilize the auger 41 in operation and to reduce wear. In a preferred embodiment, the flights 43 have a tolerance ranging from ⅜″ to ¾″ between the auger 41 and the transfer tube 42. Attached to the flights 43 are wear plates 83 that stick out approximately ⅜″. The wear plates 83 may be made of any suitable spark resistant material, but in a preferred embodiment, the wear plates 83 are made out of aluminum. When the wear plates 83 have been worn down, they can be easily replaced. This is more economical than replacing the auger 41, and also increases the safety of the system by reducing the likelihood of causing sparks that may ignite the shredded material and dust produced by the hammer mill 30.

There are times when either the location of the materials for shredding or the quantity of materials for shredding make it inconvenient to shred the materials on site. Therefore, in such cases, a transfer truck 90 according to the invention can be used to good effect to transport materials to an off-site facility where all the shredding can be done in one place.

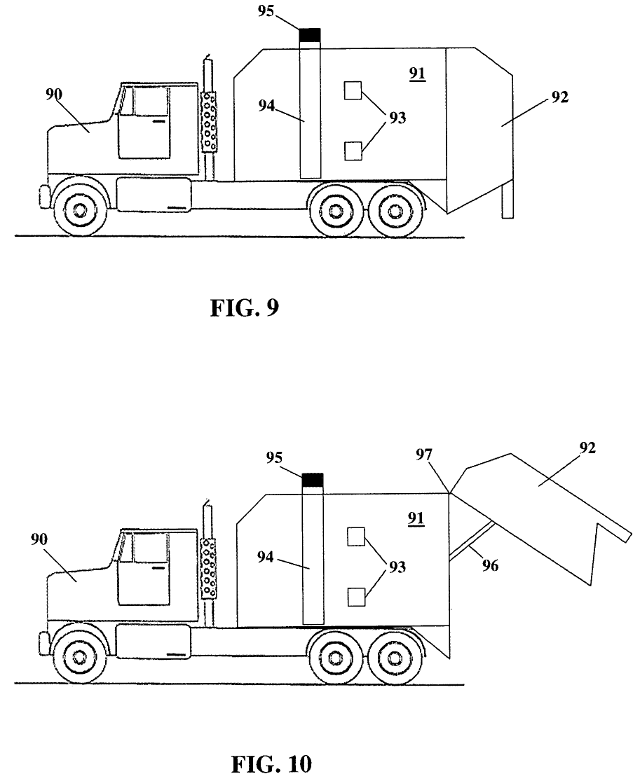

FIG. 9 shows a transfer truck 90 according to the invention. The transfer truck 60 will have at least one compartment 91 for storing materials for shredding. The compartment may have windows 93 to indicate the level of materials in the compartment 61. It may also have a bin lift 94 on the outside of the compartment 91 to raise materials to an opening 95 in the compartment 91 for receiving materials for shredding later. The compartment will have a rear door 92, which may have a clamshell shape. The clamshell shape increases the storage space available in the compartment 91. As shown in FIG. 10, the door 92 opens outwardly and upwardly from the compartment 91 from a hinged point 97 at the top of the door 92. This manner of opening reduces concerns over height restrictions within the shredding facility that can occur with other transfer trucks. It also makes it easier to ensure that no materials for shredding are left behind because any materials previously resting within the area of the door 92 will naturally fall out and down onto the pile.

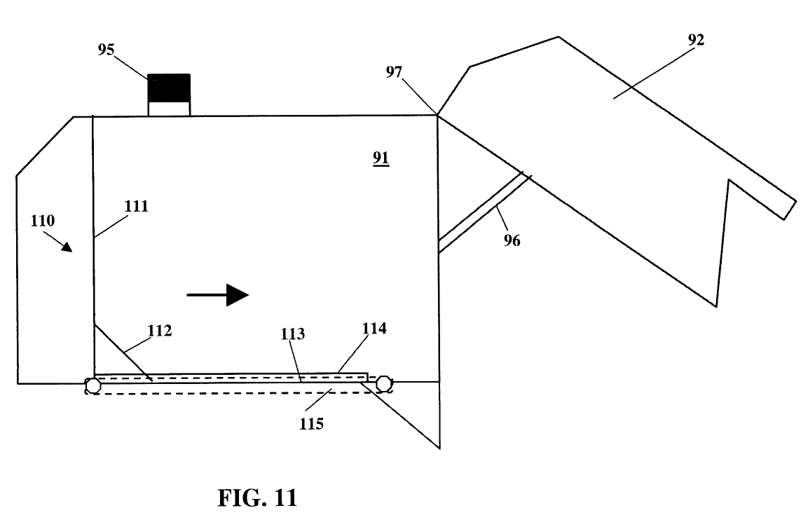

The transfer truck 90 also has an ejector wall 110 in the compartment 91, as shown in FIGS. 11, 12 and 13. The ejector wall 110 may be driven by a chain drive 115, by the truck's hydraulics 117, or by some other combination of the two. The ejector wall 110 is capable of movement towards or away from the door 92. The ejector wall 110 coupled with the door 92 permits the materials for shredding that are being stored in the compartment 91 to be pushed out of the compartment 91 and dumped on the ground to be fed into a shredder, such as the paper shredder assembly 1 as disclosed in the present invention. The ejector wall 110 may have a vertical portion 111 and an angled portion 112 adjacent the floor 114. The angled portion 112 acts as a scoop to ensure that materials are not left behind in the compartment 91. The ejector wall 110 may have some other shape above the angled portion 112 to conform to the shape of the compartment 91. The ejector wall 70 may also be used to compress materials intermittently toward the clamshell door 62 as the compartment 61 is getting more full.

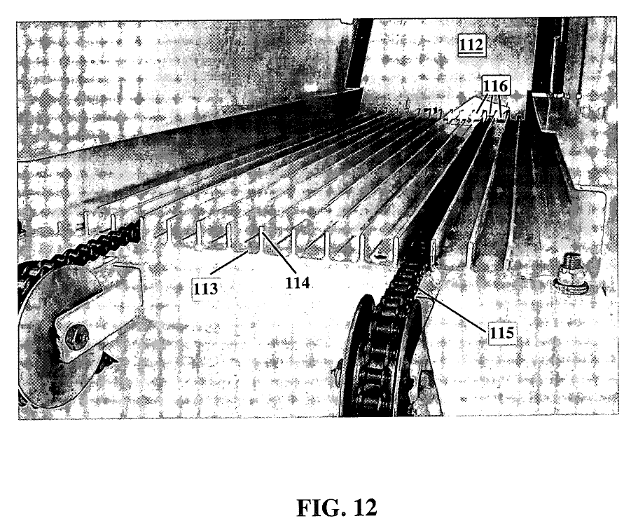

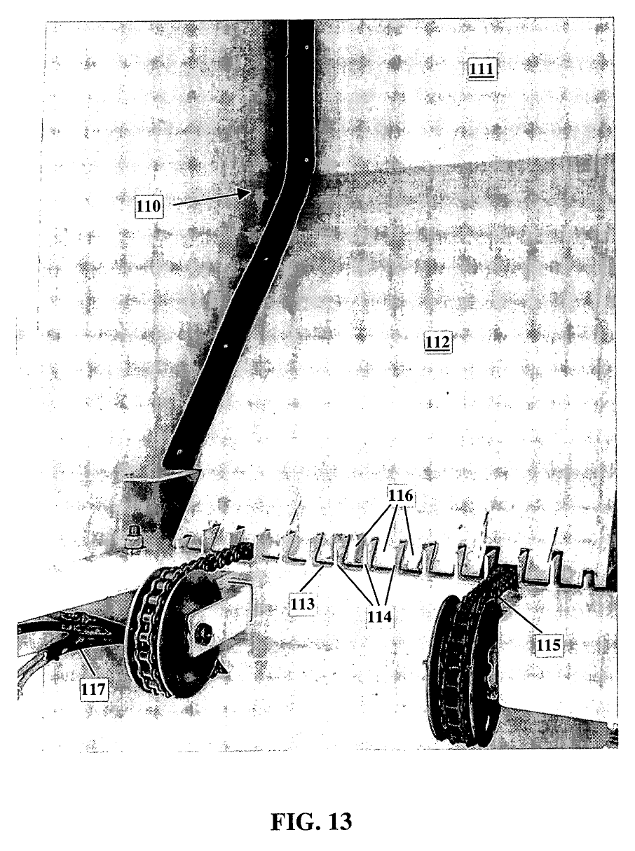

The floor 113 of the compartment 91 may have ribs 114 to further ensure that materials for shredding are not left behind. As shown in one embodiment in FIGS. 12 and 13, the ribs 114 are narrow and perpendicular to the door 92 of the compartment 91. The ribs 114 may be evenly spaced. The ejector wall 110 has scrapers 116 at the bottom of the angled portion 112 conforming to the spaces in between the ribs 114. As the ejector wall 110 advances within the compartment 91 towards the door 92, the scrapers 116 move forward in between the ribs 114, so that any material for shredding that has come to rest between the ribs 114 is pushed forward by the scrapers 116. The tolerance between the scrapers 116 and the ribs 114 may be as little as is necessary to ensure the ejector wall 110 is capable of forward movement while at the same time the scrapers 116 continue to act to prevent any materials for shredding from being left behind in the compartment 91.

The transfer truck 90 may have more than one compartment 91. Having more than one compartment 91 allows for sorting of the materials at the time of collection, rather than later at the time of offloading. This provides a great savings in terms of time, manpower, and space required at the shredding facility. Likewise, multiple compartments allow for independent offloading of materials for shredding which also provides a space savings. Paper materials can be offloaded and shredded, followed by other recyclables.

In the claims, the term “paper shredding implements” includes the described preferred hammers 32 and associated components, but any suitable paper shredding implements may be used. The term “shredded paper disposal container” includes the container 4 but may include any suitable container, fixed or removable.

Immaterial modifications may be made to the embodiments of the invention described here without departing from the invention.

1. A paper shredder, comprising:
a feed compartment;
paper shredding implements disposed to receive paper from the feed compartment and discharge shredded paper; and
an auger disposed within a transfer tube to receive shredded paper discharged by the paper shredding implements and to convey shredded materials to a storage container, the auger having flights and wear plates on the flights to stabilize the auger within the transfer tube.

2. The paper shredder of claim 1 in which the wear plates are made of spark resistant material.

3. The paper shredder of claim 1 in which the wear plates are replaceable.

4. A paper shredder, comprising:
a feed compartment;
paper shredding implements disposed to receive paper from the feed compartment and discharge shredded paper;
an auger disposed to receive shredded paper discharged by the paper shredding implements and to convey shredded materials to a storage container, the auger being driven by a direct drive from a vehicle transmission drive shaft.

5. A transfer truck for transporting materials for shredding, comprising:
a frame mounted on wheels;
at least one compartment for storing materials for shredding mounted on the frame, the compartment comprising a top, a floor, sides, an ejector wall, an opening for receiving materials for shredding, and a door for offloading materials for shredding;
the ejector wall capable of movement towards and away from the door to push out materials for shredding from the transfer truck.

6. The transfer truck of claim 5, in which the floor is ribbed.

7. The transfer truck of claim 5, in which the ejector wall has an angled portion and a vertical portion, the angled portion being adjacent to the floor and the vertical portion extending to the top.
